(19) United States
(12) Patent Application Publication
(10) Pub. No.: US 2017/0287004 A1
(43) Pub. Date: Oct. 5, 2017

(54) SELECTING A CONTENT ITEM FROM A SET FOR PRESENTATION TO A USER BASED ON LOCATIONS ASSOCIATED WITH THE CONTENT ITEMS AND A LOCATION ASSOCIATED WITH THE USER

(71) Applicant: Facebook, Inc., Menlo Park, CA (US)

(72) Inventors: Charles Joseph Hughes, San Francisco, CA (US); Blake Ethan Williams, London (GB); Joseph Paul Devoy, III, San Francisco, CA (US)

(21) Appl. No.: 15/089,457

(22) Filed: Apr. 1, 2016

(51) Int. Cl. G06Q 30/02

(52) U.S. Cl. CPC G06Q 30/0261; G06Q 30/0273; G06Q 30/0277; G06Q 30/0249

(57) ABSTRACT

An online system receives a content unit identifying a set of content items each associated with a physical location. Different content items of the set include different content associated with different physical locations. When the online system selects content from the content unit for presentation to a user, the online system selects a content item of the set identified by the content unit based on physical locations associated with the content items and characteristics of the user maintained by the online system. For example, the online system selects a content item of the set associated with a physical location having a minimum distance to a location associated with the user by the online system. Rules associate interactions by the user with content from the content unit with an object associated with the content unit or with another object associated with a selected content item of the identified set.

### BACKGROUND

This disclosure relates generally to online systems, and more specifically to presenting content to users of an online system.

Online systems, such as social networking systems, allow users to connect to and to communicate with other users of the online system. Users may create profiles on an online system that are tied to their identities and include information about the users, such as interests and demographic information. The users may be individuals or entities, such as corporations or charities. Online systems allow users to easily communicate and share content with other online system users by providing content to an online system for presentation to other users. Content provided to an online system by a user may be declarative information provided by a user, status updates, check-ins to locations, images, photographs, videos, text data, or any other information a user wishes to share with additional users of the online system. An online system may also generate content for presentation to a user, such as content describing actions taken by other users on the online system.

Additionally, many online systems commonly allow users (e.g., businesses) to sponsor presentation of content on an online system to gain public attention for a user's products or services or to persuade other users to take an action regarding the user's products or services. Content for which the online system receives compensation in exchange for presenting to users is referred to as “sponsored content.” Many online systems receive compensation from a user for presenting other online system users with certain types of sponsored content provided by the user. Frequently, online systems charge a user for each presentation of sponsored content to an online system user or for each interaction with sponsored content by an online system user. For example, an online system receives compensation from a user each time a content item provided by the user is displayed to another user on the online system, each time another user interacts with a content item from the user presented by the online system (e.g., selects a link included in the content item), or each time another user performs another action after being presented with the content item (e.g., visits a physical location associated with the user who provided the content item to the online system).

Content items may be associated with targeting criteria that identify characteristics of online system users eligible to be presented with the content item. For example, a content item is eligible to be presented to an online system user having characteristics satisfying at least a threshold amount of targeting criteria associated with the content item; however, the content item is not eligible to be presented to another online system user having characteristics satisfying less than the threshold amount of targeting criteria associated with the content item. Targeting criteria associated with a content item are often specified by a user providing the content item to an online system, and allow an online system to identify users who are most likely to be interested in being presented with a particular content item as eligible be presented with the content item.

Some content items may be more relevant to some users than to other users based on physical locations associated with the users. To identify users, targeting criteria associated with content items may identify a threshold distance from a physical location associated with the content items, so a content item is eligible for presentation to users associated with locations within a threshold distance of a physical location associated with the content item. For example, a content item associated with a restaurant includes targeting criteria specifying a threshold distance from the physical location of the restaurant for a current location of an online system user or for another location associated with the online system user.

However, a user may provide an online system with multiple content items associated with different locations for a business or organization, with different targeting criteria associated with each content item based on locations for each business or organization. For example, a user with multiple restaurant locations provides the online system with content items for each restaurant location; content items for different restaurant locations have different targeting criteria based on threshold distances from physical locations corresponding to different restaurant locations. While providing multiple content items for different locations of a business or organization to an online system allows a user to inform online system users of the different locations and to increase a number of online system users eligible to be presented with content items identifying the business or organization, if an online system user is associated with a location that satisfies targeting criteria included in content items associated with different content items corresponding to different locations of a business, the online system selects between the content items corresponding to the different locations of the business. This causes the content items for different locations of the business to compete with each other for presentation to the user when a user's location satisfies targeting criteria for different content items. As a user provides the content items for different locations of the business, selecting between the different content items for different locations of the business may increase the amount provided to the online system to the user, as the content items for different locations of the business compete with each other for selection by the online system. Additionally, providing multiple content items for different locations of a business becomes increasingly difficult for a user as the number of locations of the business increases.

### SUMMARY

In some embodiments, the online system receives a content unit from a user. The content unit includes targeting criteria identifying characteristics of users eligible to be presented with content from the content unit and identifies a set of content items that are each associated with a physical location. In various embodiments, different content items of the set include different content, allowing different content items to provide content specific to different physical locations. The content unit may include content that is common to multiple content items of the set, so content presented to a user includes the common content and content specific to a selected content item of the set of content items. For example, the content unit includes a logo of an organization and a name of the organization, while different content items of the set of content items include contact information and images for branches of the organization at different physical locations.

An object maintained by the online system, such as a page, may be associated with the content unit and additional objects, such as additional pages, may be associated with different content items identified by the content unit. One or more rules associated with the content unit identify how the online system associates interactions with content presented by the content unit. For example, one or more rules identify interactions with content presented by the content unit that the online system associates with the object with the content unit and identify other interactions with content presented by the content unit that the online system associates with an additional object associated with a selected content item presented via the content unit.

If the online system selects content unit identifying a set of content items for presentation to a user, the online system selects a content item of the set identified by the content unit for presentation to the user. In some embodiments, the online system selects a content item of the set identified by the content unit based on characteristics associated with the user by the online system and physical locations associated with content items of the set. For example, the online system obtains a location associated with the user by the online system and determines distances between the location associated with the user and physical locations associated with each content item of the set identified by the content unit. Based on the determined distances, the online system selects a content item of the set identified by the content unit associated with a physical location having a minimum distance to the location associated with the user. Alternatively, the online system retrieves one or more models associated with the user that determine a likelihood of the user performing one or more interactions with content items and determines a likelihood of the user interacting with each content item of the set identified by the content unit. The online system selects a content item of the set identified by the content unit with which the user has a maximum likelihood of interacting.

When the user interacts with the selected content item of the set identified by the content unit, a client device presenting the selected content item communicates information identifying the interaction and the selected content item to the online system. Based on one or more rules associated with the content unit, the online system stores information associating the interaction with an object associated with the content unit or with an additional object associated with the selected content item presented to the user.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is an example of a content unit identifying a set of content items each associated with a physical location, in accordance with an embodiment.

FIG. 4 is a flowchart of a method for selecting a content item of a set of content items included in a content unit for presentation to a user of an online system, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

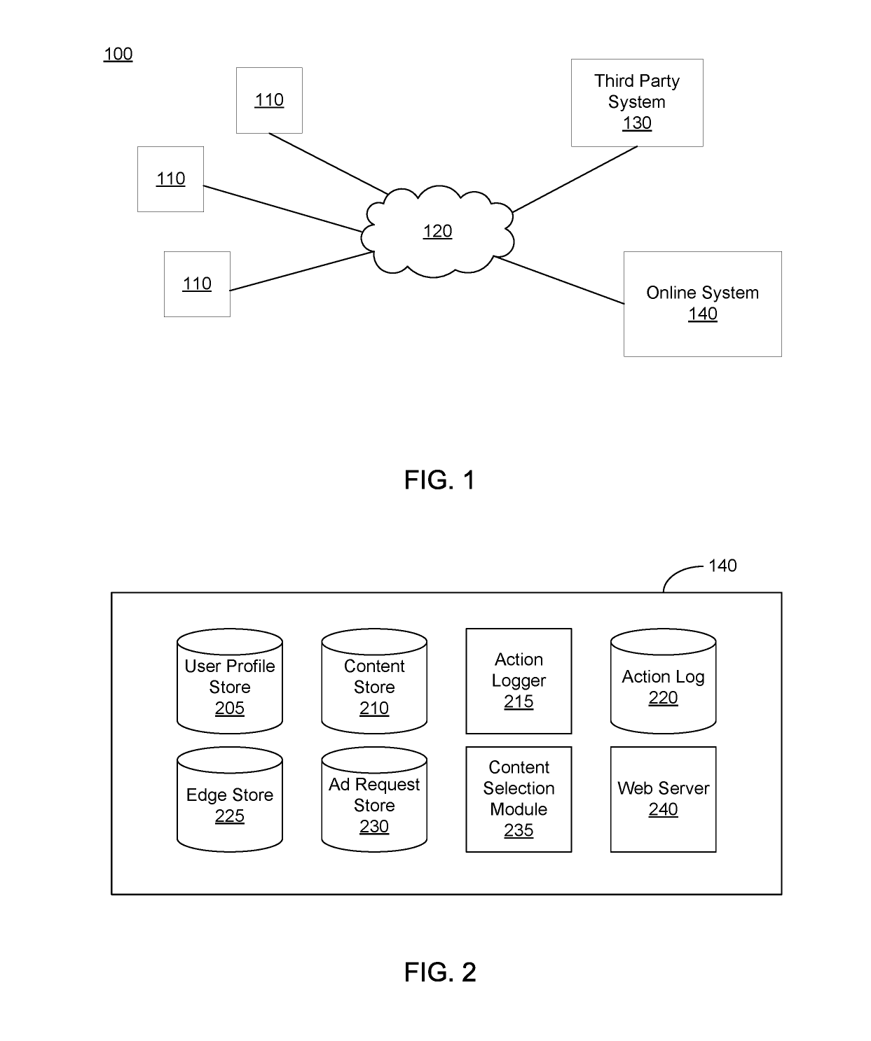

FIG. 1 is a block diagram of a system environment 100 for an online system 140, such as a social networking system. The system environment 100 shown by FIG. 1 comprises one or more client devices 110, a network 120, one or more third-party systems 130, and the online system 140. In alternative configurations, different and/or additional components may be included in the system environment 100. The embodiments described herein can be adapted to social networking systems as well.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, a smartwatch, or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

FIG. 2 is a block diagram of an architecture of the online system 140. The online system 140 shown in FIG. 2 includes a user profile store 205, a content store 210, an action logger 215, an action log 220, an edge store 225, an advertisement (“ad”) request store 230, a content selection module 235, and a web server 240. In other embodiments, the online system 140 may include additional, fewer, or different components for various applications. Conventional components such as network interfaces, security functions, load balancers, failover servers, management and network operations consoles, and the like are not shown so as to not obscure the details of the system architecture. In one embodiment, the online system 140 is a social networking system.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system using a brand page associated with the entity's user profile. Other users of the online system may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

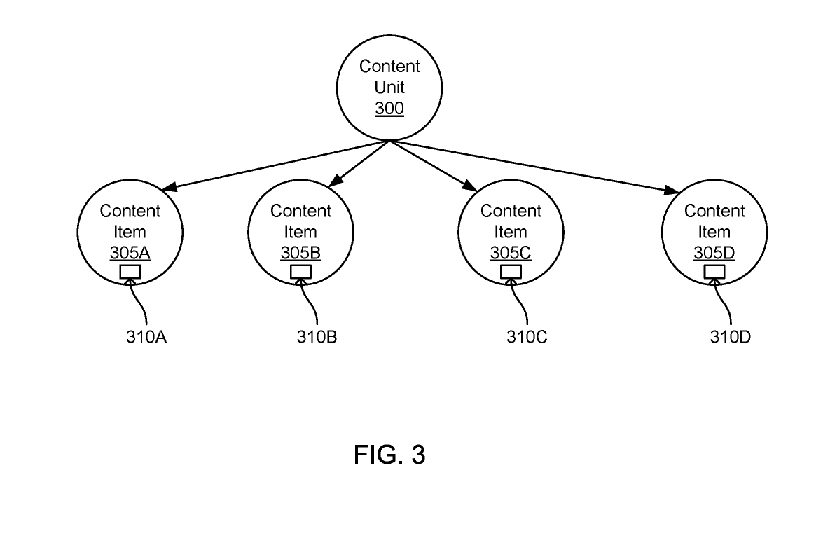

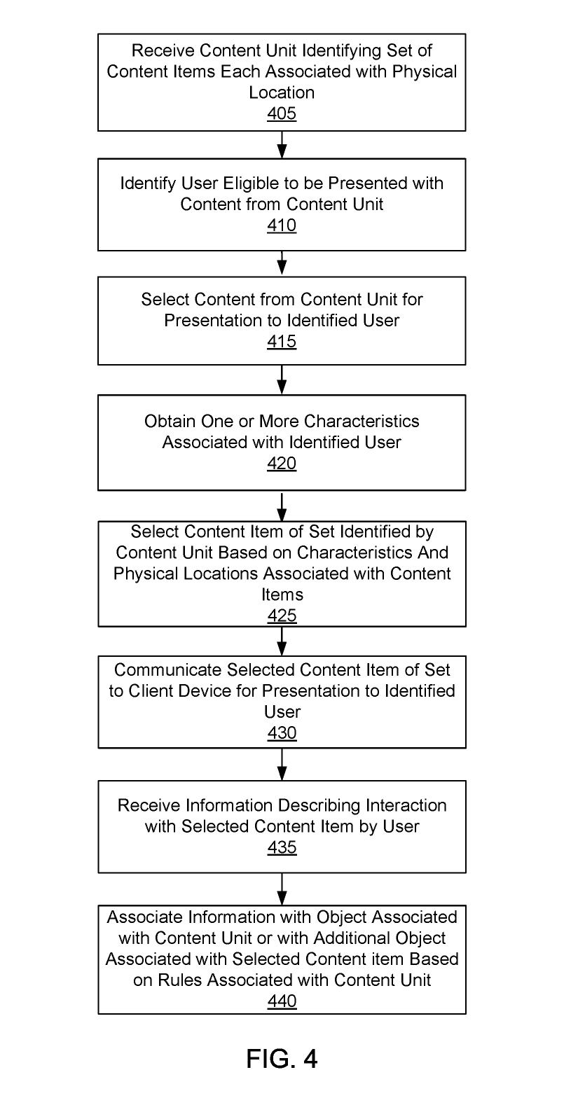

In some embodiments, the content store 210 includes one or more content units. A content unit includes targeting criteria identifying characteristics of users eligible to be presented with content from the content unit and identifies a set of content items, with each content item associated with a physical location. FIG. 3 shows an example of a content unit 300. In the example of FIG. 3, the content unit 300 identifies a set of content items 305A-305D. Content item 305A is associated with physical location 310A, and content item 305B is associated with physical location 310B. Similarly, content item 305C is associated with physical location 310C, while content item 305D is associated with physical location 310C. As further described below in conjunction with FIG. 4, when the content unit 300 is selected for presentation to a user of the online system 140, the online system 140 selects a content item of the set of content items 305A-305D for presentation. For example, the online system 140 selects a content item of the set of content items 305A-305D based on the physical locations 310A-310D associated with the content items 305A-305D and a location associated with the user by the online system 140.

The content unit 300 may include content that is common to multiple content items 305A-305D of the set, so content presented to a user includes the common content and content specific to a selected content item of the set of content items 305A-305D. For example, the content unit 300 includes a logo of an organization and a name of the organization, while different content items of the set of content items 305A-305D include contact information and images for branches of the organization at different physical locations. If content item 305A of the set of content items 305A-305D is selected, content presented by the content unit 300 includes the logo and the name of the organization, from the content unit 300, and contact information and images from content item 305A. Alternatively, the content unit 300 does not itself include content, so content from a selected content item 305A-305D is presented when the content unit 300 is presented to a user. An object (e.g., a page) in the content store 210 may be associated with the content unit 300 and additional objects in the content store 210 may be associated with different content items 305A-305D identified by the content unit 300. One or more rules associated with the content unit 300 identify how the online system 140 associates interactions with content presented by the content unit 300. For example, one or more rules identify interactions with content presented by the content unit 300 that the action logger 215 associates with the object associated with the content unit 300 in the action log 225 and other interactions with content presented by the content unit 300 that the action logger 215 associates with an additional object associated with a selected content item 305A-305D presented via the content unit 300 in the action log 225.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce web sites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate a user's interest in an object, a topic, or another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

One or more advertisement (“ad”) requests are included in the ad store 230. An ad request is received from an advertiser for presentation to users of the online system 140 and the ad request may be included in an advertisement campaign (“ad campaign”) by the advertiser. Each ad request includes an advertisement, which is content presented to an online system user. Ad content may be text data, image data, audio data, video data, or any other suitable data. Additionally, an advertisement may include a link or destination address associated with a source of content associated with the ad request that is presented to the user if the user accesses the ad content when it is presented. For example, the destination address identifies a landing page including content that is presented to the user when the user accesses the advertisement.

Additionally, an ad request include a bid amount specifying an amount of compensation a user (e.g., an advertiser) associated with the ad request provides the online system 140 for presenting the advertisement included in the ad request, for a user interacting with the presented advertisement included in the ad request, or for another suitable interaction with a presented advertisement from the ad request by a user. Based on the bid amount included in an ad request, the online system 140 determines an expected value for presenting the advertisement included in the ad request to a user. For example, the expected value is an amount of monetary compensation received by the online system 140 from an advertiser for presenting the advertisement to a user, for a user interacting with the presented advertisement, or based on any other suitable condition. In one embodiment, the expected value of an ad request is a product of the bid amount and a probability of the advertisement of the ad request being accessed by the user if presented.

In some embodiments, an ad request included in the ad request store 230 is a content unit identifying a set of advertisements, with each advertisement associated with a physical location. As further described above in conjunction with FIG. 3, different advertisements in the set are associated with different physical locations. Different advertisements in the set also have different content, such as content based on a physical location associated with an advertisement.

Additionally, ad requests may be associated with one or more targeting criteria. An advertiser may specify targeting criteria associated with an ad request or may specify targeting criteria associated with multiple ad requests included in an ad campaign. Targeting criteria specify one or more characteristics of users eligible to be presented with an ad content included in an ad request associated with the targeting criteria. Associating different targeting criteria with different ad requests allows an advertiser to tailor presentation of ad content to users having specific characteristics, allowing ad requests including different advertisements to be presented to users with different characteristics. For example targeting criteria specify demographic information, connections, or actions associated with a user. In some embodiments, targeting criteria may be associated with an ad campaign including multiple ad requests, so multiple ad requests in the ad campaign are associated with the targeting criteria.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users who have taken a particular action, such as sending a message to another user, using an application, joining a group, leaving a group, joining an event, generating an event description, purchasing or reviewing a product or service using an online marketplace, requesting information from a third-party system 130, or any other suitable action. Including actions in targeting criteria allows advertisers to further refine users eligible to be presented with advertisements from various ad requests. As another example, targeting criteria identifies users having a connection to another user or object or having a particular type of connection to another user or object.

Additional information may be associated with an ad request. For example, the ad request or ad campaign includes a budget that specifies a total amount of compensation an advertiser provides the online system 140 for presenting an advertisement included in the ad request or included in ad requests associated with an ad campaign. The budget may be allocated for the ad campaign as a whole or per ad request. If the ad request is a content unit identifying a set of advertisements, instructions for allocating the budget among various advertisements of the set of advertisements. The instructions may identify one or more criteria for allocating the budget for presentation of different advertisements of the set of advertisements identified by the ad request. For example, the instructions specify modification of a bid amount for an advertisement of the set identified by the ad request based on a number of times the advertisement has been presented to users of the online system 140 within a time interval or based on a number of one or more particular interactions with the advertisement within a time interval. The instructions may also include other suitable information describing allocation of a budget among advertisements of a set identified by an ad request that is a content unit.

The content selection module 235 selects one or more content items for communication to a client device 110 to be presented to a user. In various embodiments, the content selection module 235 determines a measure of relevance of various content items to the user based on characteristics associated with the user by the online system 140 based on the user's affinity for different content items and selects content items for presentation to the user based on the determined measures of relevance. For example, the content selection module 235 selects content items having the highest measures of relevance or having at least a threshold measure of relevance for presentation to the user. Alternatively, the content selection module 235 ranks content items based on their associated measures of relevance and selects content items having the highest positions in the ranking or having at least a threshold position in the ranking for presentation to the user.

Content items selected for presentation to the user may include ad content. When selecting ad content, the content selection module 235 uses bid amounts associated with various ad requests. In various embodiments, the content selection module 235 determines an expected value associated with various ad requests and selects ad requests associated with a maximum expected value or at least a threshold expected value for presentation. An expected value associated with an ad request represents an expected amount of compensation to the online system 140 for presenting ad content from the ad request. For example, the expected value associated with an ad request is a product of the ad request's bid amount and a likelihood of the user interacting with the ad content from the ad request. The content selection module 235 may rank ad requests based on their associated bid amounts and select ad requests having at least a threshold position in the ranking for presentation to the user. In some embodiments, the content selection module 235 may rank both content items and ad requests in a unified ranking based on bid amounts associated with ad request and measures of relevance associated with content items and ad requests. Based on the unified ranking, the content selection module 235 selects content for presentation to the user. Selecting ad requests and other content items through a unified ranking is further described in U.S. patent application Ser. No. 13/545,266, filed on Jul. 10, 2012, which is hereby incorporated by reference in its entirety.

If the content selection module 235 selects a content unit identifying a set of content items, which may be advertisements, for presentation to a user, the content selection module 235 selects a content item of the set identified by the content unit for presentation to the user. In some embodiments, the content selection module 235 selects a content item of the set based on characteristics associated with the user by the online system 140 and physical locations associated with content items of the set. For example, the content selection module 235 obtains a location associated with the user from a user profile in the user profile store 205 associated with the user and determines distances between the location associated with the user and physical locations associated with each content item of the set identified by the content unit. Based on the determined distances, the content selection module 235 selects a content item of the set identified by the content unit associated with a physical location having a minimum distance to the location associated with the user. Alternatively, the content selection module 235 retrieves one or more models associated with the user that determine a likelihood of the user performing one or more interactions with content items and determines a likelihood of the user interacting with each content item of the set identified by the content unit. The content selection module 235 selects a content item of the set identified by the content unit with which the user has a maximum likelihood of interacting. Selection of a content item of a set identified by the content unit is further described below in conjunction with FIG. 4.

The web server 240 links the online system 140 via the network 120 to the one or more client devices 110, as well as to the one or more third party systems 130. The web server 240 serves web pages, as well as other content, such as JAVA®, FLASH®, XML and so forth. The web server 240 may receive and route messages between the online system 140 and the client device 110, for example, instant messages, queued messages (e.g., email), text messages, short message service (SMS) messages, or messages sent using any other suitable messaging technique. A user may send a request to the web server 240 to upload information (e.g., images or videos) that are stored in the content store 210. Additionally, the web server 240 may provide application programming interface (API) functionality to send data directly to native client device operating systems, such as IOS®, ANDROID™, WEBOS® or BlackberryOS.

Selecting a Prompt for Performing an Action to Present in Association with Ad Content

FIG. 4 is a flowchart of one embodiment of a method for selecting a content item of a set of content items included in a content unit for presentation to a user of an online system 140. In other embodiments, the method may include different and/or additional steps than those shown in FIG. 4. Additionally, steps of the method may be performed in different orders than the order described in conjunction with FIG. 4.

The online system 140 receives 405 a content unit identifying a set of content items and including targeting criteria. In various embodiments, the set includes two or more content items. Each content item in the set of content items is associated with a physical location and includes content that is based at least in part on the physical location. For example, different content items in the set identify different locations of an organization. As a specific example, different content items in the set include addresses or images of different locations of the organizations, such as addresses and images of different restaurants in a chain. In some embodiments, the content unit includes the various content units in the set. Alternatively, the content unit includes identifiers associated with various content units in the set, allowing the online system 140 to retrieve stored content units associated with different identifiers. In some embodiments, certain content is common to different content items of the set, with other content in different content items differing. The content unit may be an advertisement (“ad”) request with the content items of the set comprising various advertisements, as further described above in conjunction with FIG. 2.

Targeting criteria identifies characteristics of users eligible to be presented with a content item from the set of content items identified by the content unit, as further described above in conjunction with FIG. 2. As an example, a user having characteristics satisfying at least a threshold number of the targeting criteria is eligible to be presented with a content item from the set. In another example, a user having characteristics satisfying at least a threshold percentage of the targeting criteria is eligible to be presented with a content item from the set. Targeting criteria may include a threshold distance between a location associated with a user and physical locations associated a content item of the set.

In some embodiments, information obtained by the online system 140 associates an object maintained by the online system 140 with the content unit and associates additional content items with content items of the set of content items identified by the content unit. Information associating an object with the content unit and additional objects with content items of the set may be included in the content unit or may be separately received by the online system 140 and identify the content unit. For example, information obtained by the online system 140 associates a page of content with the content unit and also associates additional pages of content with each content item of the set identified by the content unit. As an example, information associates the content unit with a page maintained by the online system 140 for a corporation and also associates different content items of the set identified by the content unit with different store locations of the corporation. Additionally, the online system 140 receives one or more rules that associate interactions by a user with a presented content item from the content unit with the object associated with the content unit or with an additional object associated with the presented content item. For example, the one or more rules identify interactions with a presented content from the content unit that are associated with the object associated with the content unit itself and alternative interactions with the presented content item that are associated with an additional object associated with the presented content item. Hence, the one or more rules specify criteria for the online system 140 to associate interactions by users with presented content items of the set of content items with objects maintained by the online system 140 and associated with the content unit or with objects maintained by the online system 140 and associated with content items of the set identified by the content unit.

Based on the targeting criteria included in the content unit and characteristics associated with online system users, the online system 140 identifies 410 a user of the online system 140 eligible to be presented with content from the content unit. For example, a user associated with at least a threshold number of characteristics satisfying the targeting criteria in the content unit is identified 410 as eligible to be presented with a content item from the content unit. Example characteristics included in targeting criteria are described above in conjunction with FIG. 2. In embodiments where the targeting criteria included in the content unit identifies a physical location, the online system 140 identifies 410 the user as eligible to be presented with content from the content unit if a location associated with the user is within a threshold distance of a physical location associated with at least one content item of the set of content items. Hence, the online system 140 identifies 410 a user associated with a location within a threshold distance of a physical location associated with at least one content item in the set as eligible to be presented with content from the content unit if characteristics of the user, including the location, satisfy the threshold number (or the threshold percentage) of targeting criteria included in the content unit.

The online system 140 includes the content unit in one or more selection processes that select content for presentation to the identified user. As described above in conjunction with FIG. 2, the one or more selection processes determine measures of relevance of various content items eligible for presentation to the user, including the content unit, based on characteristics associated with the user by the online system 140 based on the user's affinity for different content items and selects content items for presentation to the user based on the determined measures of relevance. For example, a selection process selects a content item having at least a threshold measure of relevance or ranks content items based on their measures of relevance and selects one or more content items having at least a threshold position in the ranking for presentation to the identified user. Hence, if the content unit has at least a threshold measure of relevance to the identified user, the selection process in the previous example selects 415 content from the content unit for presentation to the identified user. If the content unit is an advertisement request (“ad request”) that includes a bid amount, the one or more selection processes account for the bid amount and bid amounts associated with other content items when selecting content for presentation to the identified user. For example, a selection process ranks the ad request identifying the set of advertisements and other ad requests based on their bid amounts and selects an ad request having at least a threshold position. In another example, a selection process selects an ad request having a maximum bid amount or having at least a threshold bid amount. Hence, in the preceding examples, the online system 140 selects 415 content from the ad request identifying the set of advertisements having at least a threshold position in a ranking based on bid amounts of ad request or having at least a threshold bid amount, respectively.

In response to selecting 415 content from the content unit for presentation to the identified user, the online system 140 obtains 420 one or more characteristics associated with the identified user by the online system 140 and selects 425 a content item of the set of content items identified by the content unit based on the one or more characteristics associated with the identified user. As an example, the one or more characteristics associated with the identified user include a location associated with the identified user. The location may be a location specified by the identified user (e.g., a hometown, a current location) or a location received from a client device 110 associated with the identified user (e.g., a location of the client device 110 communicated to the online system 140 subject to privacy settings specified by the identified user and maintained by the client device 110). The online system 140 selects 425 a content item of the set of content items based on the location associated with the identified user and the physical locations associated with content items of the set of content items. In various embodiments, the online system 140 determines distances between the location associated with the identified user and physical locations associated with each content item of the set of content items and selects 425 a content item of the set of content item associated with a physical location having a minimum distance to the location associated with the identified user.

In other embodiments, the online system 140 generates a likelihood of the identified user interacting with each content item of the set of content items by applying a model to at least a set of the obtained one or more characteristics associated with the identified user and characteristics of each content item of the set of content items. Hence, a likelihood of the identified user interacting with a content item of the set is generated by applying a model to at least a set of the obtained characteristics associated with the identified user and characteristics of the content item. The online system 140 selects 425 a content item of the set of content items associated with a maximum likelihood of interaction by the identified user. In various embodiments, the model applied to the obtained characteristics and to characteristics of content items of the set of content items is associated with the identified by the online system 140 and trained based on prior interactions by the identified user with content items of the set of content items or prior interactions by the identified user with other content items having at least a threshold number of characteristics (or a threshold percentage of characteristics) matching characteristics of content items of the set of content items. Additionally, the online system 140 further trains the model using interaction with content items of the set of content items by one or more additional online system users who have at least a threshold number (or at least a threshold percentage) of characteristics matching characteristics of the identified user. Selecting 425 a content item of the set of content items based on likelihoods of the identified user interacting with different content items of the set of content items allows the online system 140 to select 425 a content item of the set with which the user is most likely to interact.

If the content unit is an ad request, a user providing the ad request to the online system 140 may specify a budget for presenting advertisements of the set of content items. In some embodiments, the user providing the ad request to the online system 140 also provides instructions for allocating the budget among different advertisements of the set of content items. The online system 140 decreases the budget allocated to the selected content item based on the instructions by an amount determined by the one or more selection processes. In other embodiments, the online system 140 allocates the budget to different advertisements of the set of content items identified by the ad request based on criteria determined by the online system 140 or specified by received instructions. If the portion of the budget allocated to the selected advertisement is exceeded when the selected advertisement is selected 425, the online system 140 selects 425 another advertisement of the set of content items or selects another content item.

The online system 140 communicates 430 the selected content item of the set of content items to a client device 110 associated with the identified user for presentation. For example, the selected content item is included in a feed of content communicated 430 to the client device 110 associated with the identified user for presentation when the client device 110 presents the feed of content to the identified user. If the identified user interacts with the selected content item presented by the client device 110, the online system 140 receives 430 information describing the interaction from the client device 110 and retrieves 435 one or more rules associated with the content unit.

In response to the one or more rules determining that the interaction with the selected content item presented by the client device 110 is associated with the object associated with the content unit, the online system 140 associates 440 the interaction with the object associated with the content unit. However, in response to the one or more rules determining that the interaction with the selected content item presented by the client device 110 is associated with an additional object associated with the presented content item of the set of content items identified by the content unit, the online system 140 associates 440 the interaction with the additional object associated with the selected content item. For example, the one or more rules determine whether the online system 140 associates an interaction with the selected content item presented to the identified user with an object associated with the content unit or associates the interaction with the selected content item with an additional object associated with the selected content item.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving, at an online system, a content unit including targeting criteria and identifying a set of content items each associated with a physical location and including content based on the physical location;
identifying a user of the online system having of characteristics satisfying at least a threshold number of the targeting criteria included in the content unit;
selecting content from the content unit for presentation to the user;
obtaining a location associated with the user by the online system;
selecting a content item of the set of content items identified by the content unit based on distances between the location associated with the user and physical locations associated with each of the content items of the set of content items; and
communicating the selected content item of the set of content items to a client device for presentation to the user.

2. The method of claim 1, wherein selecting the content item of the set of content items identified by the content unit based on distances between the location associated with the user and physical locations associated with each of the content items of the set of content items comprises:
selecting a content item of the set of content items associated with a physical location having a minimum distance to the location associated with the user.

3. The method of claim 1, wherein the content unit is associated with an object maintained by the online system and each content item of the set of content items is associated with an additional object maintained by the online system.

4. The method of claim 3, further comprising:
receiving an interaction by the user with the selected content item from the client device;
retrieving one or more rules associated with the content unit by a user who provided the content unit to the online system; and
associating the received interaction with an additional object associated with the selected content item and maintained by the online system in response to the one or more rules determining to associate the received interaction with the additional object associated with the selected content item.

5. The method of claim 4, further comprising:
associating the received interaction with the object associated with the content unit and maintained by the online system in response to the one or more rules determining to associate the received interaction with the object associated with the content unit.

6. The method of claim 3, wherein the object is a page and each additional object comprises an additional page.

7. The method of claim 3, wherein the object is associated with an organization and each additional object is associated with a location of the organization.

8. The method of claim 1, wherein the content unit comprises an advertisement request (“ad request”) and each content item of the set of content items comprises an advertisement.

9. The method of claim 1, wherein the content unit is associated with a budget, and the online system allocates the budget among the content items of the set of content items based on one or more criteria.

10. A method comprising:
receiving, at an online system, a content unit including targeting criteria and identifying a set of content items each associated with a physical location and including content based on the physical location;
identifying a user of the online system having of characteristics satisfying at least a threshold number of the targeting criteria included in the content unit;
selecting content from the content unit for presentation to the user;
obtaining one or more characteristics associated with the user by the online system;
selecting a content item of the set of content items identified by the content unit based on the one or more characteristics associated with the user by the online system; and
communicating the selected content item of the set of content items to a client device for presentation to the user.

11. The method of claim 10, wherein selecting the content item of the set of content items identified by the content unit based on the one or more characteristics associated with the user by the online system comprises:
determining a location associated with the user from the one or more characteristics associated with the user by the online system; and
selecting a content item of the set of content items associated with a physical location having a minimum distance to the location associated with the user.

12. The method of claim 10, wherein selecting the content item of the set of content items identified by the content unit based on the one or more characteristics associated with the user by the online system comprises:
generating a likelihood of interaction by the user with each of the content items of the set of content items, the likelihood of the user interacting with a content item of the set of content items determined by applying a model to at least a set of the one or more characteristics associated with the user and to characteristics of the content item of the set of content items; and
selecting a content item of the set of content items associated with a maximum likelihood of interaction by the user.

13. The method of claim 12, wherein the model is trained based on prior interactions by the user with the content items of the set of content items or with content items having at least a threshold number of characteristics matching characteristics of content items of the set of content items.

14. The method of claim 12, wherein the model is further trained based on interactions on prior interactions with the content items of the set of content items by one or more additional users of the online system having at least a threshold number of characteristics matching characteristics of the user.

15. The method of claim 10, wherein the content unit is associated with an object maintained by the online system and each content item of the set of content items is associated with an additional object maintained by the online system.

16. The method of claim 15, further comprising:
receiving an interaction by the user with the selected content item from the client device;
retrieving one or more rules associated with the content unit by a user who provided the content unit to the online system; and
associating the received interaction with an additional object associated with the selected content item and maintained by the online system in response to the one or more rules determining to associate the received interaction with the additional object associated with the selected content item.

17. The method of claim 16, further comprising:
associating the received interaction with the object associated with the content unit and maintained by the online system in response to the one or more rules determining to associate the received interaction with the object associated with the content unit.

18. The method of claim 10, wherein the content unit comprises an advertisement request (“ad request”) and each content item of the set of content items comprises an advertisement.

19. A computer program product comprising a computer readable storage medium having instructions encoded thereon that, when executed by a processor, cause the processor to:
receive, at an online system, a content unit including targeting criteria and identifying a set of content items each associated with a physical location and including content based on the physical location;
identify a user of the online system having of characteristics satisfying at least a threshold number of the targeting criteria included in the content unit;
select content from the content unit for presentation to the user;
obtain one or more characteristics associated with the user by the online system;
select a content item of the set of content items identified by the content unit based on the one or more characteristics associated with the user by the online system; and
communicate the selected content item of the set of content items to a client device for presentation to the user.

20. The computer program product of claim 19, wherein select the content item of the set of content items identified by the content unit based on the one or more characteristics associated with the user by the online system comprises:
determine a location associated with the user from the one or more characteristics associated with the user by the online system; and
select a content item of the set of content items associated with a physical distance having a minimum distance to the location associated with the user.
